(19) United States
(12) Patent Application Publication
(10) Pub. No.: US 2007/0039339 A1
(43) Pub. Date: Feb. 22, 2007

(54) Refrigerator and operation control method thereof

(75) Inventor: Jung-hun Lee, Gwangju-City (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/434,275

(22) Filed: May 16, 2006

(30) Foreign Application Priority Data
Aug. 18, 2005 (KR) 2005-75579

(51) Int. Cl. G05D 23/32; F25B 39/04

(52) U.S. Cl. 62/183; 62/158

(57) ABSTRACT

The foregoing and/or other aspects of the present invention can be achieved by providing a refrigerator including a partition wall defining a plurality of storage compartments, and a hot pipe extended from a condenser and embedded in a front area of the partition wall, the refrigerator further including: a cooling fan to cool the condenser; an outside temperature sensor; a front area temperature sensor to sense temperature of the front area; and a controller to control the cooling fan to operate when a predetermined delay time elapses after a compressor operates in the case where sensed front area temperature is lower than sensed outside temperature by a reference temperature difference or more. Accordingly, it is an aspect of the present invention to provide a refrigerator and an operation control method thereof, which can increase the temperature of a hot pipe to prevent dew from being formed on a front area.

### CROSS-REFERENCE TO RELATED APPLICATIONS

This application claims the benefit of Korean Patent Application No. 2005-0075579, filed on Aug. 18, 2005, in the Korean Intellectual Property Office, the disclosure of which is incorporated herein by reference.

### BACKGROUND OF THE INVENTION

1. Field of the Invention

The present invention relates to a refrigerator and an operation control method thereof, and more particularly, to a refrigerator and an operation control method thereof, which can prevent dew from being formed on a front area.

2. Description of the Related Art

In general, a refrigerator is used for storing food at a low temperature. As shown in FIG. 1, the refrigerator includes a main body 1 formed with a plurality of storage compartments 3 and 4; a door (not shown) for opening and closing each storage compartment 3, 4; and a cooling system cooling each storage compartment 3, 4 to maintain a proper temperature of the stored food.

The cooling system includes a compressor 11 to compress a high-temperature and low-pressure refrigerant into a high-temperature and high-pressure refrigerant; a condenser 12 to condense a compressed gaseous refrigerant into a liquid refrigerant; a capillary tube 14 to adiabatically expand a condensed low-temperature and high-pressure refrigerant; and evaporators 15a and 15b to evaporate the expanded refrigerant, thereby generating cool air. Here, the compressor 11, the condenser 12, the capillary tube 14 and the evaporators 15a and 15b are connected through refrigerant pipes.

Among these refrigerant pipes, the refrigerant pipes between the condenser 12 and the capillary tube 14 are called a cluster pipe 13 and a hot pipe 20. In particular, the hot pipe 20 is used to prevent a front area 6 from dew condensation due to difference in temperature between the inside and the outside of the refrigerator. Generally, as the temperature of the hot pipe 20 rises, the temperature of the front area 6 becomes closer to an outside temperature Tₛ. Thus, it is advantageous to preventing the dew condensation.

However, in order to improve the efficiency of the refrigerator, the conventional refrigerator and the operation control method thereof have been continuously developed to lower the temperature of the condenser. The lowered temperature of the condenser has an effect on the temperature of the hot pipe connected thereto, so that the temperature of the front area is also lowered, thereby causing the dew condensation.

The dew formed on the front area deteriorates the outer appearance of the refrigerator. Further, if the dew penetrates a power supplying unit, problems such as a fire, an electric shock, etc. may arise.

### SUMMARY OF THE INVENTION

Accordingly, it is an aspect of the present invention to provide a refrigerator and an operation control method thereof, which can increase the temperature of a hot pipe to prevent dew from being formed on a front area.

Additional aspects and/or advantages of the present invention will be set forth in part in the description which follows and, in part, will be apparent from the description, or may be learned by practice of the present invention.

The foregoing and/or other aspects of the present invention can be achieved by providing a refrigerator including a partition wall defining a plurality of storage compartments, and a hot pipe extended from a condenser and embedded in a front area of the partition wall, the refrigerator further including: a cooling fan to cool the condenser; an outside temperature sensor; a front area temperature sensor to sense temperature of the front area; and a controller to control the cooling fan to operate when a predetermined delay time elapses after a compressor operates in the case where sensed front area temperature is lower than sensed outside temperature by a reference temperature difference or more.

According to another aspect of the present invention, the controller controls the cooling fan to operate when the delay time elapses after the compressor operates in the case where the outside temperature ranges between dew condensation temperatures and where difference between the front area temperature and the outside temperature is smaller than the reference temperature difference.

According to another aspect of the present invention, the controller controls the cooling fan to operate at the same time when the compressor operates in the case where the outside temperature is out of the range between the dew condensation temperatures.

According to another aspect of the present invention, the refrigerator further includes a memory to store a delay time table in which the delay times according to the outside temperature and the front area temperature are previously tabulated, wherein the controller delays the operation of the cooling fan by a corresponding delay time when the sensed outside temperature and the sensed front area temperature are equal to an outside temperature and a front area temperature previously tabulated in the delay time table, respectively.

According to another aspect of the present invention, the dew condensation temperature approximately ranges from 20° C. through 38° C.

According to another aspect of the present invention, the reference temperature difference is about 2° C.

According to another aspect of the present invention, the delay time ranges from 5 minutes to 10 minutes.

According to another aspect of the present invention, the refrigerator further includes a memory to store a delay time table in which the delay times according to the outside temperature and the front area temperature are previously tabulated, wherein the controller delays the operation of the cooling fan by a corresponding delay time when the sensed outside temperature and the sensed front area temperature are equal to an outside temperature and a front area temperature previously tabulated in the delay time table, respectively.

The foregoing and/or other aspects of the present invention can be also achieved by providing an operation control method for a refrigerator to prevent dew from being formed on a front area of a partition wall defining storage compartments, the method including: sensing outside temperature; sensing temperature of the front area; controlling a cooling fan to operate when a predetermined delay time elapses after a compressor operates in the case where the sensed front area temperature is lower than the sensed outside temperature by a reference temperature difference or more.

According to another aspect of the present invention, the method further includes setting a range of dew condensation temperatures; wherein the controlling the cooling fan includes controlling the cooling fan to operate when the delay time elapses after the compressor operates in the case where the outside temperature ranges between the dew condensation temperatures and the front area temperature is lower than the outside temperature by the reference temperature difference or more.

According to another aspect of the present invention, the method further includes controlling the cooling fan to operate at the same time when the compressor operates in the case where the outside temperature is out of the range between the dew condensation temperatures and difference between the front area temperature and the outside temperature is smaller than the reference temperature difference.

### BRIEF DESCRIPTION OF THE DRAWINGS

The above and/or other aspects and advantages of the present invention will become apparent and more readily appreciated from the following description of the embodiments, taken in conjunction with the accompany drawings of which:

FIG. 1 is a perspective view schematically illustrating a cooling system of a refrigerator according to an embodiment of the present invention;

FIG. 2 is a block diagram of the refrigerator according to an embodiment of the present invention;

FIG. 3 is a control flowchart of an operation control method for the refrigerator according to an embodiment of the present invention;

FIG. 4 shows operation states of a compressor and a cooling fan according to an embodiment of the present invention; and

FIG. 5 is a table showing time delay according to an embodiment of the present invention.

### DETAILED DESCRIPTION OF THE PREFERRED EMBODIMENTS

Hereinafter, embodiments of the present invention will be described with reference to accompanying drawings. Further, a side by side refrigerator will be exemplarily described below, but not limited thereto.

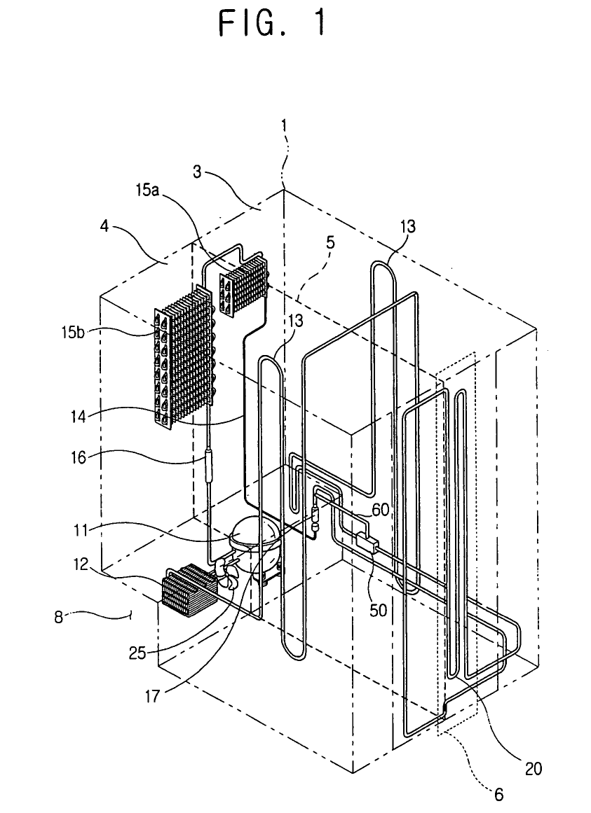

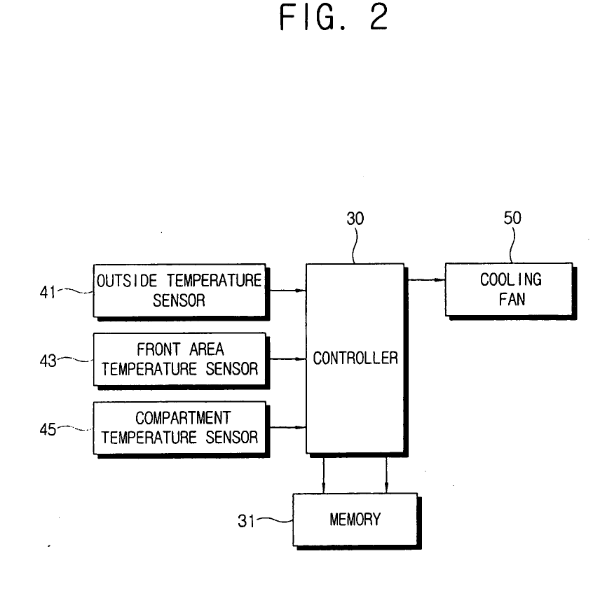

FIG. 1 is a perspective view schematically illustrating a cooling system of a refrigerator according to an embodiment of the present invention, and FIG. 2 is a block diagram of the refrigerator according to an embodiment of the present invention.

As shown therein, a refrigerator according to an embodiment of the present invention includes a main body 1; a cooling system provided in the main body 1; a partition wall 5 partitioning the main body 1 into a plurality of storage compartments 3, 4; a hot pipe 20 extended from a condenser 12 and embedded in a front area 6; a cooling fan 25 to cool the condenser 12; an outside temperature sensor 41; a front area temperature sensor 43 to sense the temperature of the front area 6; and a controller 30 to control the cooling fan 25 on the basis of a sensed outside temperature Tₛ and a front area temperature Tₘ.

Further, the refrigerator can include a memory 31 to store a delay time table of delay times t_{d} which are previously set according to the outside temperature Tₛ and the front area temperature Tₘ.

The main body 1 is formed with the plurality of storage compartments 3 and 4 partitioned with the partition wall 5. For example, there are two storage compartments 3 and 4, which are a refrigerator compartment 3 having a relatively high temperature, and a freezer compartment 4 having a relatively low temperature. As shown in FIG. 1, the refrigerator compartment 3 and the freezer compartment 4 may be disposed left and right or up and down with respect to the partition wall 5, respectively. Further, three or more storage compartments may be provided.

The cooling system includes a compressor 11 to compress a high temperature and low pressure refrigerant into a high temperature and high pressure refrigerant; the condenser 12 to condense a compressed gaseous refrigerant into a liquid refrigerant; a capillary tube 14 to adiabatically expand a condensed low-temperature and high pressure refrigerant; and evaporators 15a and 15b to evaporate the expanded refrigerant, thereby generating cool air. As shown in FIG. 1, the evaporators 15a and 15b can be provided in the storage compartments 3 and 4, respectively. Alternatively, a single evaporator may be provided.

Meanwhile, the cooling system may further include a drier 17 provided between the condenser 12 and the capillary tube 14 for removing moisture from the refrigerant supplied from the condenser 12; and an accumulator 16 provided between the evaporators 15a and 15b and the compressor 11 for preventing the liquid refrigerant from flowing toward the compressor 11.

The hot pipe 20 is extended from the condenser 12 and disposed along the front area 6 of the partition wall 5. The temperature of the refrigerant flowing in the hot pipe 20 is lower than that of the refrigerant passing through the compressor 11, but is higher than that of the inside of the storage compartments 3 and 4. Therefore, the hot pipe 20 transfers heat to the front area 6, thereby preventing dew from being formed on the front area 6 due to difference in temperature between the inside and the outside of the storage compartments 3 and 4.

The cooling fan 25 is provided in a component compartment 8 and cools the condenser 12. Here, the controller 30 controls the cooling fan 25 to operate on the basis of sensed results of the outside temperature sensor 41 and the front area temperature sensor 43. That is, the cooling fan 25 can either operate (common operation) at the same time when the compressor 11 operates, or operate (delay operation) when a preset delay time t_{d} elapses after the compressor 11 operates. In the latter case, cooling the condenser 12 is delayed, so that the temperature of the refrigerant passing through the hot pipe 20 increases.

The outside temperature sensor 41 senses of the outside temperature of the refrigerator. The sensed result of the outside temperature sensor 41 is input to the controller 30, and thus the controller 30 determines whether the outside temperature Tₛ ranges between dew condensation temperatures Tₛ₁ and Tₛ₂ on the basis of the sensed result.

The dew condensation temperatures Tₛ₁ and Tₛ₂ are defined as a range of the outside temperatures in which dew is very likely to be formed on the front area 6. The dew condensation temperatures Tₛ₁ and Tₛ₂ may vary according to an operating environment of the refrigerator. For example, the dew condensation temperature may range from 20° C. to 38° C. In the case where the outside temperature Tₛ is lower than the lowest dew condensation temperature, e.g., 20° C., the humidity of the outside is lowered, so that the dew is rarely condensed. On the other hand, in the case where the outside temperature Tₛ is higher than the highest dew condensation temperature, e.g., 38° C., the cooling system continuously operates and the temperature of the refrigerant is relatively high, so that the temperature of the front area 6 is high enough to prevent the dew from being formed thereon.

The front area temperature sensor 43 is provided in the main body 1 and senses the temperature of the front area 6. Because the temperature of the front area 6 reflects the temperatures of the storage compartments 3 and 4, the dew is formed when the difference in temperature between the outside temperature Tₛ and the front area temperature Tₘ is large.

In the case where the sensed outside temperature Tₛ ranges between the dew condensation temperatures Tₛ₁ and Tₛ₂ , and the sensed front area temperature Tₘ is lower than the sensed outside temperature Tₛ by a reference temperature difference R_{T} or more, the controller 30 controls the cooling fan 25 to operate when the preset delay time t_{d} elapses after the compressor 11 operates. On the other hand, in the case where the sensed outside temperature Tₛ is out of the range between the dew condensation temperatures Tₛ₁ and Tₛ₂ , and the difference between the sensed front area temperature Tₘ and the sensed outside temperature Tₛ is smaller than the reference temperature difference R_{T}, the controller 30 controls the cooling fan 25 to operate at the same time when the compressor 11 operates.

The controller 30 determines whether the outside temperature Tₛ sensed by the outside temperature sensor 41 ranges between the dew condensation temperatures Tₛ₁ and Tₛ₂ . When the outside temperature Tₛ ranges between the dew condensation temperatures Tₛ₁ and Tₛ₂ , the controller 30 determines whether the difference between the outside temperature Tₛ and the sensed front area temperature Tₘ is larger than the reference temperature difference R_{T}. In the case where the outside temperature Tₛ is out of the range between the dew condensation temperatures Tₛ₁ and Tₛ₂, the controller 30 does not compare the front area temperature Tₘ and the outside temperature Tₛ, and controls the cooling fan 25 to commonly operate (i.e., sets the cooling fan 5 to operate at the same time when the compressor 11 operates or sets a delay time t_{d} with ‘0’).

The reference temperature difference R_{T} is set to determine whether the delay operation of the cooling fan 25 is needed in the case where the outside temperature Tₛ ranges between the dew condensation temperatures Tₛ₁ and Tₛ₂. For example, even though the outside temperature Tₛ ranges between the dew condensation temperatures Tₛ₁ and Tₛ₂, the dew is not formed when the front area temperature Tₘ is close to or higher than the outside temperature Tₛ. Therefore, at this time, the controller 30 controls the cooling fan 25 to operate at the same time when the compressor 11 operates, thereby enhancing the efficiency of the cooling system.

Here, the reference temperature difference R_{T} may vary as necessary. For example, let the reference temperature R_{T} be set to 2° C. In this case, the controller 30 delays the operation of the cooling fan 25 when the outside temperature Tₛ is of 25° C. and the front area temperature Tₘ is lower than 23° C. Otherwise, the controller 30 controls the cooling fan 25 to operate at the same time when the compressor 11 operates.

Meanwhile, the delay time t_{d} is defined as a period from time when the compressor 11 operates to time when the cooling fan 25 operates. Therefore, when the delay time t_{d} is ‘0’, the cooling fan 25 operates commonly, i.e. operates at the same time when the compressor 11 operates. On the other hand, when the delay time t_{d} is not ‘0’, the cooling fan 25 operates when the delay time t_{d} elapses after the compressor 11 operates.

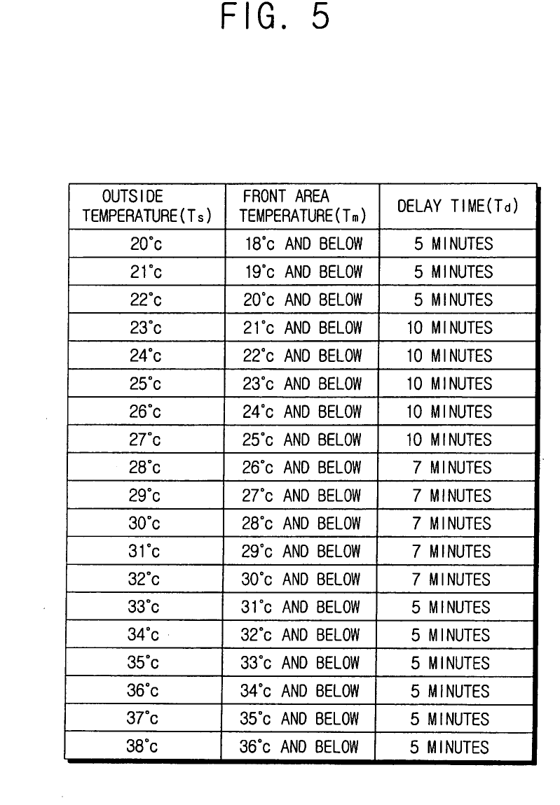

The delay time t_{d} may be uniform throughout the range between the dew condensation temperatures Tₛ₁ and Tₛ₂, or may vary according to the outside temperature Tₛ. For example, as shown in FIG. 5, the delay time t_{d} is relatively prolonged in a section between 23° C. and 32° C., in which the dew is frequently formed, as compared with other sections, thereby sufficiently increasing the temperature of the hot pipe 20.

Here, the delay times t_{d} according to the outside temperatures Tₛ can be tabulated as the delay time table, and stored in the controller 30 or a separate memory 31.

Independently of whether the outside temperature Tₛ ranges between the dew condensation temperatures Tₛ₁ and Tₛ₂ or not, the controller 30 can delay the operation of the cooling fan 25 to operate when the front area temperature Tₘ is lower than the outside temperature Tₛ by the reference temperature difference R_{T} or more.

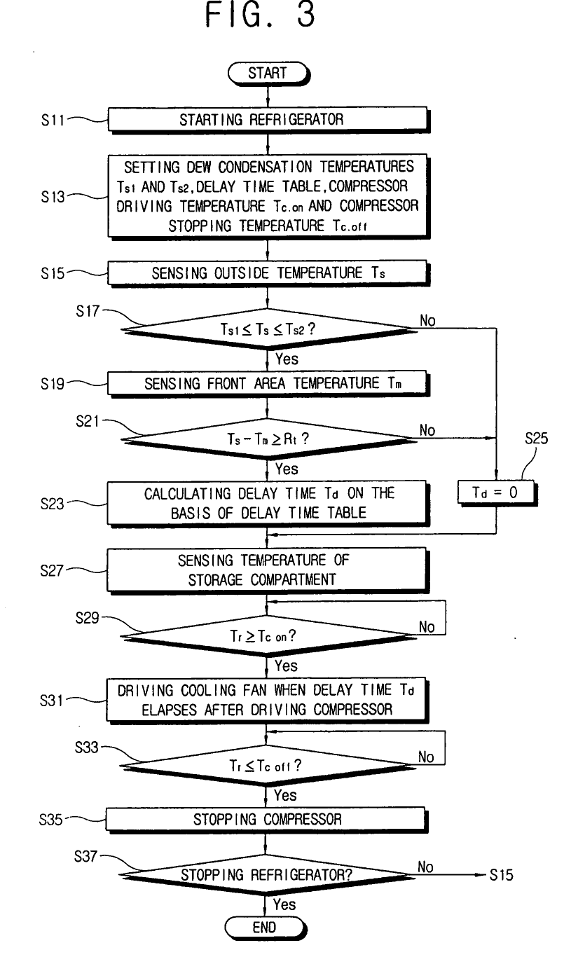

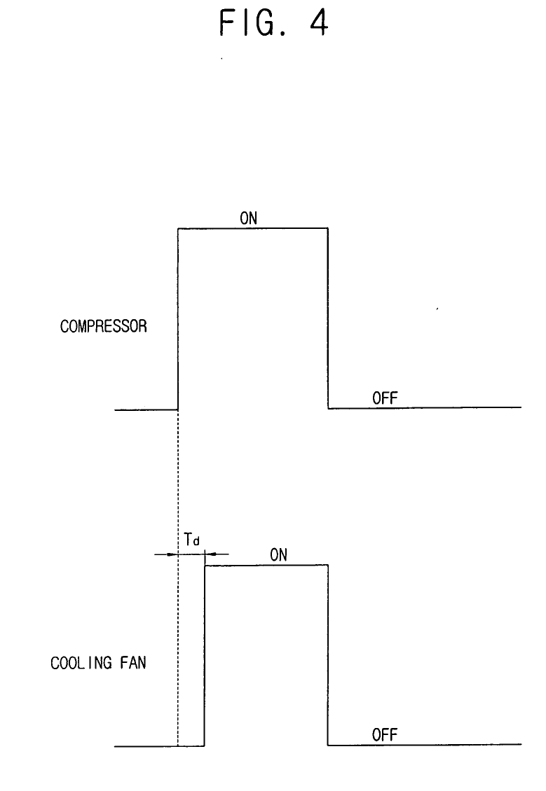

Below, the operation control method for the refrigerator with this configuration will be described with reference to FIGS. 3 through 5.

When at operation S11 the refrigerator is turned on and operated, at operation S13 the delay time table, a range between the dew condensation temperatures Tₛ₁ and Tₛ₂, a compressor driving temperature T_{c.on} and a compressor stopping temperature T_{c.off} are set.

At operation S15, the controller 30 controls the outside temperature sensor 41 to sense the outside temperature Tₛ. At operation S17, the controller 30 determines whether the outside temperature Tₛ ranges between the dew condensation temperatures Tₛ₁ and Tₛ₂. When the outside temperature Tₛ is out of the range of the dew condensation temperatures Tₛ₁ and Tₛ₂, at operation S25 the controller 30 sets the delay time t_{d} to ‘0’ (common operation).

When the outside temperature Tₛ ranges between the dew condensation temperatures Tₛ₁ and Tₛ₂, the controller 30 controls the front area temperature sensor 43 to sense the front area temperature Tₘ at operation S19, and determines whether the sensed front area temperature Tₘ is lower than the sensed outside temperature Tₛ by the reference temperature difference R_{T} or more at operation S21. Even though the outside temperature Tₛranges between the dew condensation temperatures Tₛ₁ and Tₛ₂, when the difference between the sensed front area temperature Tₘ and the sensed outside temperature Tₛ is smaller than the reference temperature difference R_{T,} the delay time t_{d} is set to ‘0’ at the operation S25 (common operation).

In the case where the outside temperature Tₛ ranges between the dew condensation temperatures Tₛ₁ and Tₛ₂, and the sensed front area temperature Tₘ is lower than the sensed outside temperature Tₛ by the reference temperature difference R_{T} or more, the delay time t_{d} is calculated on the basis of the delay time table stored in the controller 30 or the memory 31 at operation S27 (delay operation). At this time, the delay time t_{d} can be calculated on the basis of the previously stored delay time table (refer to FIG. 5).

In other words, the delay time t_{d} is not ‘0’ only when the outside temperature Tₛ ranges between the dew condensation temperatures Tₛ₁ and Tₛ₂, and the sensed front area temperature Tₘ is lower than the sensed outside temperature Tₛ by the reference temperature difference R_{T} or more. Otherwise, the delay time t_{d} is not ‘0’.

Then, the controller 40 controls a compartment temperature sensor to sense the temperature Tᵣ of the storage compartments 3 and 4 at operation S27, and compares it with the compressor driving temperature T_{c.on} at operation S29. When the compressor 11 has to operate, i.e., when the temperature Tᵣ is higher than the compressor driving temperature T_{c.on,} the controller 30 controls the cooling fan 25 to operate when the calculated delay time t_{d} elapses after the compressor 11 operates. Here, the delay time t_{d} is either of ‘0’ or not.

Referring to FIG. 5, in the case where the outside temperature Tₛ is 25° C. and the front area temperature Tₘ is of 21° C. the front area temperature Tₘ is lower than the outside temperature Tₛ by the reference temperature difference R_{T} or more, so that the controller 30 calculates the delay time t_{d} as ‘10’ minutes. In this case, when ‘10’ minutes elapse after driving the compressor 11, the controller 30 controls the cooling fan 25 to operate. On the other hand, in the case where the outside temperature Tₛ is 25° C. and the front area temperature Tₘ is 24° C., the difference between the front area temperature Tₘ and the outside temperature Tₛ is smaller than the reference temperature difference R_{T}i.e., smaller than 2° C. even though the outside temperature Tₛ ranges between the dew condensation temperatures Tₛ₁ and Tₛ₂, so that the controller 30 calculates the delay time t_{d} as ‘0’. In this case, the controller 30 controls the cooling fan 25 to operate at the same time when the compressor 11 operates.

Then, the cooling fan 25 operates normally. When the compressor 11 stops, i.e. when the temperature Tᵣ is lower than the compressor stopping temperature T_{c.off} at operation S33, the controller 30 controls the compressor 11 to stop at operation S35. As long as the refrigerator operates, the foregoing operations are repeated until the compressor 11 satisfies the driving conditions.

As described above, the present invention provides a refrigerator and an operation control method thereof, which can delay an operation of a cooling fan according to an outside temperature and a front area temperature, and therefore increase the temperature of a hot pipe, thereby preventing dew from being formed on a front area.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A refrigerator including a partition wall defining a plurality of storage compartments, and a hot pipe extended from a condenser and embedded in a front area of the partition wall, the refrigerator comprising:
a cooling fan to cool the condenser;
an outside temperature sensor;
a front area temperature sensor to sense temperature of the front area; and
a controller to control the cooling fan to operate when a predetermined delay time elapses after a compressor operates in the case where sensed front area temperature is lower than sensed outside temperature by a reference temperature difference or more.

2. The refrigerator according to claim 1, wherein the controller controls the cooling fan to operate when the delay time elapses after the compressor operates in the case where the outside temperature ranges between dew condensation temperatures and where difference between the front area temperature and the outside temperature is smaller than the reference temperature difference.

3. The refrigerator according to claim 2, wherein the controller controls the cooling fan to operate at the same time when the compressor operates in the case where the outside temperature is out of the range between the dew condensation temperatures.

4. The refrigerator according to claim 1, further comprising a memory to store a delay time table in which the delay times according to the outside temperature and the front area temperature are previously tabulated,
wherein the controller delays the operation of the cooling fan by a corresponding delay time when the sensed outside temperature and the sensed front area temperature are equal to an outside temperature and a front area temperature previously tabulated in the delay time table, respectively.

5. The refrigerator according to claim 4, wherein the dew condensation temperature approximately ranges from 20° C. through 38° C.

6. The refrigerator according to claim 5, wherein the reference temperature difference is about 2° C.

7. The refrigerator according to claim 6, wherein the delay time ranges from 5 minutes to 10 minutes.

8. The refrigerator according to claim 2, further comprising a memory to store a delay time table in which the delay times according to the outside temperature and the front area temperature are previously tabulated,
wherein the controller delays the operation of the cooling fan by a corresponding delay time when the sensed outside temperature and the sensed front area temperature are equal to an outside temperature and a front area temperature previously tabulated in the delay time table, respectively.

9. The refrigerator according to claim 8, wherein the dew condensation temperature approximately ranges from 20° C. through 38° C.

10. The refrigerator according to claim 9, wherein the reference temperature difference is about 2° C.

11. The refrigerator according to claim 10, wherein the delay time ranges from 5minutes to 10 minutes.

12. An operation control method for a refrigerator to prevent dew from being formed on a front area of a partition wall defining storage compartments, the method comprising:
sensing outside temperature;
sensing temperature of the front area;
controlling a cooling fan to operate when a predetermined delay time elapses after a compressor operates in the case where the sensed front area temperature is lower than the sensed outside temperature by a reference temperature difference or more.

13. The method according to claim 12, further comprising:
setting a range of dew condensation temperatures;
wherein the controlling the cooling fan comprises controlling the cooling fan to operate when the delay time elapses after the compressor operates in the case where the outside temperature ranges between the dew condensation temperatures and the front area temperature is lower than the outside temperature by the reference temperature difference or more.

14. The method according to claim 13, further comprising controlling the cooling fan to operate at the same time when the compressor operates in the case where the outside temperature is out of the range between the dew condensation temperatures and difference between the front area temperature and the outside temperature is smaller than the reference temperature difference.

15. The method according to claim 13, wherein the dew condensation temperature approximately ranges from 20° C. through 38°0 c.

16. The method according to claim 15, wherein the reference temperature difference is about 2° C.

17. The method according to claim 16, wherein the delay time ranges from 5 minutes to 10 minutes.

18. The method according to claim 12, wherein the reference temperature difference is about 2° C.

19. The method according to claim 18, wherein the delay time ranges from 5 minutes to 10 minutes.

20. The method according to claim 13, further comprising:
storing a delay time table in which the delay times according to the outside temperature and the front area temperature are previously tabulated; and
delaying the operation of the cooling fan by a corresponding delay time when the sensed outside temperature and the sensed front area temperature are equal to an outside temperature and a front area temperature previously tabulated in the delay time table, respectively.
